(19) United States
(12) Patent Application Publication
(10) Pub. No.: US 2018/0180496 A1
(43) Pub. Date: Jun. 28, 2018

(54) STRAIN SENSOR AND RECORDING MEDIUM

(71) Applicant: Konica Minolta, Inc., Tokyo (JP)

(72) Inventors: Hideo UEMURA, Tokyo (JP); Kazuki IKEDA, Tokyo (JP)

(21) Appl. No.: 15/849,177

(22) Filed: Dec. 20, 2017

(30) Foreign Application Priority Data
Dec. 26, 2016 (JP) 2016-250394

(51) Int. Cl. G01L 1/22; G01B 11/16; G01L 1/24

(52) U.S. Cl. CPC G01L 1/2293; G01L 1/247; G01B 11/161

(57) ABSTRACT

A strain sensor includes a marker, a light source, a first detector, a second detector and a calculator. The marker includes a strain body and surface plasmon generating particles which are arranged in the strain body in a direction normal to a light receiving surface of the strain body and in a first direction that is an in-plane direction of the light receiving surface. A strain is produced in the strain body by a load. The first detector detects a spectrum intensity of the light which has been reflected on the marker or which has passed through the marker. The second detector detects a peak of an absorption spectrum of the light. The calculator calculates the quantity of strain in the direction normal to the light receiving surface.

### BACKGROUND

### 1. Technological Field

The present invention relates to a strain sensor and a recording medium.

### 2. Description of the Related Art

In recent years, there has been an increasing need for visualization of a variety of physical quantities (e.g. displacement, load, acceleration and the like) acting on a measurement object.

One of techniques that are known in the art that meet this need is to use a structural color changeable material that changes its color according to a strain (e.g. see JP 2006-28202A). This material can change its color according to a strain since nanosized mono-dispersed particles are three-dimensionally arranged in a rubber elastic body (elastomer). To be more specific, the spacing of the lattice planes of the particles is changed according to the quantity of strain in the anti-plane direction of the material (dielectric substance), which shifts the wavelength λ of Bragg reflection and changes the color of the material accordingly. Since the material changes its color sensitively to a local strain, users can intuitively understand the strain of the material by visual observation. Therefore, the material is expected to be applied to films and fibers as a sensor material that visualizes stress concentration or strain.

In the field of sensors that visualize stress concentration or strain, it has been particularly required to develop a sensor that can used in a minute area. Further, in the field of measurement of strain, it has been required to develop a sensor that can measure a strain in a minute area. For example, the technique in JP 2006-28202A enables detection of a strain in the thickness direction, in which the lattice spacing changes according to the quantity of strain in the anti-plane direction so that the color changes due to a wavelength shift of the Bragg reflection.

The Bragg reflection-based technique in JP 2006-28202A uses the interference principle, and parameters relating to a wavelength change mostly depend on the spacing of nanoparticle layers in the thickness direction.

In order to detect a strain in the thickness direction with high accuracy using the technique in JP 2006-28202A, it is necessary to secure sufficient intensity of the reflection light. However, in order to ensure the sufficient intensity of the reflection light, it is necessary to provide tens to hundreds of periodic particle layers in the thickness direction. This results in a problem of the increased size due to the increased thickness.

### SUMMARY

The present invention has been made in view of the above-described circumstances, and an object thereof is to provide a strain sensor that can detect the quantity of strain in the thickness direction with high accuracy while an increase of the sensor size is avoided, and a strain measuring method.

To achieve at least one of the abovementioned objects, according to an aspect of the present invention, a strain sensor includes:

a marker which includes a strain body and surface plasmon generating particles which are regularly and periodically arranged in the strain body in a direction normal to a light receiving surface of the strain body and in a first direction that is an in-plane direction of the light receiving surface, in which a strain is produced in the strain body by a load;

a light source which emits light to the marker;

a first detector which detects a spectrum intensity of the light which has been reflected on the marker or which has passed through the marker;

a second detector which detects a peak of an absorption spectrum of the light which has been reflected on the marker or which has passed through the marker, based on the spectrum intensity detected by the first detector; and

a calculator which calculates the quantity of strain in the direction normal to the light receiving surface from the peak of the absorption spectrum detected by the second detector,

wherein the strain body is constituted by a transparent body, and

wherein a diameter of the particles is equal to or less than the wavelength of the light incident to the marker.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIG. 1 illustrates the schematic configuration of a strain sensor according to an embodiment;

FIG. 2A illustrates an example of the state (reference state) in which a strain body does not have a strain;

FIG. 2B illustrates an example of the state in which a strain body has a strain in the anti-plane direction;

FIG. 3 illustrates the change of a reflection light spectrum due to a strain produced in a marker;

FIG. 4 is a flowchart of the operation of a strain sensor according to the embodiment;

FIG. 5A illustrates an example plot of the relationship between peak wavelength shift and the quantity of strain which is converted from particle spacing;

FIG. 5B illustrates an example of data table illustrating the relationship between the quantity of strain in a marker and peak wavelength shift;

FIG. 6 illustrates the schematic configuration of a strain sensor according to Variation 1; and

FIG. 7 illustrates the schematic configuration of a strain sensor according to Variation 2.

### DETAILED DESCRIPTION OF EMBODIMENTS

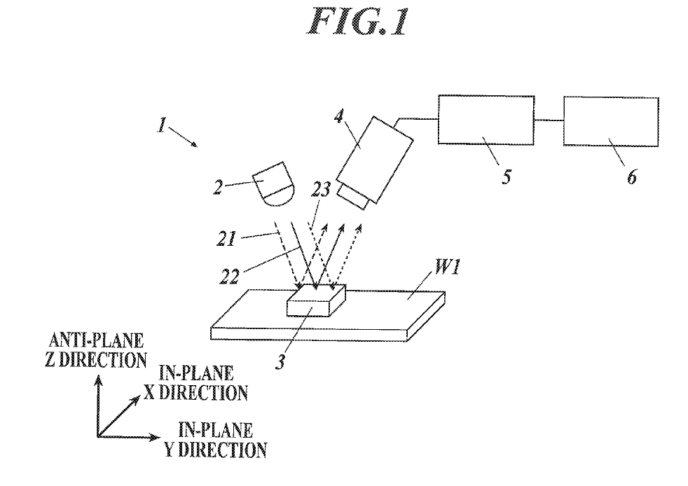

Hereinafter, one or more embodiments of the present invention will be described in detail with reference to the drawings. However, the scope of the invention is not limited to the disclosed embodiments. In the following description, the left-right direction and the up-down direction in FIG. 1 are referred to respectively as the Y direction and the Z direction, and the direction (front-back direction) perpendicular to the Y direction and the Z direction is referred to as the X direction.

Structure of Strain Sensor

A strain sensor 1 according to an embodiment of the present invention can measure the strain of a marker 3 by use of light. As illustrated in FIG. 1, the strain sensor 1 includes a light source 2, the marker 3 that is fixed on the upper face of a fixing member W1 disposed below the light source 2 in the Z direction and that reflects light emitted from the light source 2, a detector 4 that is disposed above the marker 3 in the Z direction to detect reflection light from the marker 3, a signal processor 5 that measures the strain of the marker 3 based on the light detected by the detector 4, and a storage 6.

The light source 2 emits beams 21 to 23 toward the marker 3 that is fixedly disposed below, the beams having different wavelengths.

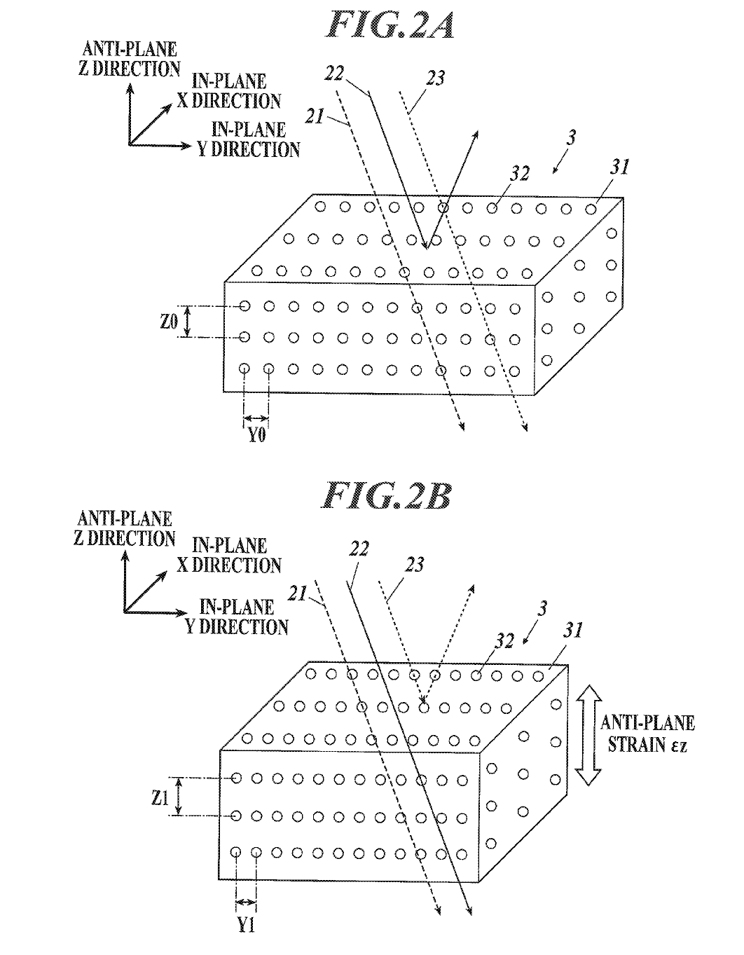

As illustrated in FIG. 2, the marker 3 includes a film strain body 31 in which a strain is produced by a load, and the surface plasmon generating particles 32 that are regularly arranged in or on the strain body 31.

The strain body 31 is constituted by an approximately square plate member of an elastic material. Examples of the elastic material of the strain body 31 include flexible and transparent elastomers such as acrylic rubbers (i.e. cross-linked polyethyl acrylate) and the like. The strain body 31 is constituted by a transparent body. The strain body 31 is constituted by a transparent body in order to allow light to reach the particles 32 inside the strain body 31 to generate plasmon inside the strain body 31. As used herein, a “transparent body” is not necessarily perfectly transparent but is defined as any material with a transmittance of 10% or more. In the embodiment, a sufficient amount of light is secured at the detector 4 when the transmittance of the strain body 31 is equal to or greater than 10%.

The particles 32 contains at least a metal. Examples of the metal of the particles 32 include gold, silver, titanium and the like. Gold and silver are preferably used since they have an absorption spectral peak of the surface plasmon in the visible region, which makes recognition by human eyes or procurement of the light source 2 and the detector 4 easier.

The size of the particles 32 is equal to or less than the wavelength of the light that is emitted from the light source 2 and incident to the marker 3. When the size of the particles 32 is equal to or less than the wavelength of the incident light to the marker 3, surface plasmon can be generated.

In particular, when the metal material of the particles 32 is gold or silver, it is preferred that the diameter of the particles 32 ranges from 50 nm to 100 nm. The particles 32 with a diameter of from 50 nm to 100 nm enables maximizing the absorption characteristic in the visible region.

The particles 32 are three dimensionally arranged in the direction (Z direction, thickness direction) normal to the reflection surface (light receiving surface of the marker 3) of incident light, a first direction (Y direction) which is an in-plane direction of the light receiving surface and a second direction (X direction) which is another in-plane direction of the light receiving surface perpendicular to the first direction. Further, the particles 32 are regularly and periodically arranged in the Z and Y directions.

FIG. 2A and FIG. 2B illustrate an example in which the beams 21 to 23 with different wavelengths are incident in the anti-plane Z direction to the surface of the strain body 31.

FIG. 2A illustrates an example of the state (reference state) in which the strain body 31 has no strain. In this state, surface plasmon is generated by the interaction between the particles 32 and the light (beams 21 to 23) so that only the beam 22 with a specific wavelength is reflected. In the reference state, the particles 32 are arranged at intervals of Z0 in the Z direction and intervals of Y0 in the Y direction.

Plasmon resonance is such that when light is incident to the particles 32, free electrons in the surface of the particles 32 resonate to absorb the light. In this state, an electric field is generated and amplified near the particles 32 by the plasmon resonance. The electric fields in the vicinities of the respective particles 32 contact with each other to cause interaction, which further enhances the plasmon resonance. This means that the plasmon resonance wavelength depends on the size of the particles 32, and the amplified electric field regions near the particles 32 depend on the particle spacing. Further, the intensity of the amplified electric fields near the particles 32 also depends of the plasmon resonance wavelength. This allows improving the absorption by the plasmon resonance by suitably selecting the size of the particles 32 and the spacing between the particles 32.

In this regard, it is more preferred that the spacing Z0 (particle spacing in the Z direction) between particles 32 adjacent in the Z direction ranges from two to ten times of the diameter of the particles 32. This is because when the particle spacing Z0 in the Z direction is less than two times of the diameter of the particles 32, the absorption spectrum of light does not exhibit linearity, and it is difficult to determine the peak of the absorption spectrum. When the particle spacing Z0 in the Z direction is greater than ten times of the diameter of the particles 32, surface plasmon is not generated at all, and no peak is present in the absorption spectrum.

Further, it is more preferred that the spacing Y0 (particle spacing in the Y direction) of particles 32 adjacent in the Y direction is equal to or greater than the diameter of the particles 32. This is because when the particle spacing Y0 in the Y direction is less than the diameter of the particles 32, the absorption spectrum of light does not exhibit linearity, and it is difficult to determine the peak of the absorption spectrum.

FIG. 2B illustrates an example of the state in which the strain body 31 has a strain εz in the anti-plane Z direction, and the particle spacing is changed both in the anti-plane Z direction and in the in-plane Y direction according to the strain εz.

To be more specific, the particle spacing is expanded in the Z direction, which is the direction of the strain, and is narrowed in the X direction, which is perpendicular to the direction of the strain. This causes a resonance wavelength shift of the surface plasmon and thus changes the reflection wavelength. As a result, as illustrated in FIG. 2B, the beam 22 is no longer reflected, and only the beam 23 having a specific wavelength different from the beam 22 is reflected.

That is, the anti-plane strain εz causes a wavelength shift corresponding to the Z direction, and this enables detection of a strain.

The detector 4 receives the light (beams 21 to 23) reflected on the marker 3 and detects the spectrum intensity thereof. The spectrum intensity of the light detected by the detector 4 is output to the signal processor 5. That is, the detector 4 functions as a first detector of the present invention.

The signal processor 5 detects the peak of the absorption spectrum of the light reflected on the marker 3 based on the spectrum intensity of the light output from the detector 4. Then, the signal processor 5 calculates the quantity of strain in the Z direction of the marker 3 based on the detected peak of the absorption spectrum. That is, the signal processor 5 functions as a second detector and a calculator of the present invention.

The storage 6 is constituted by an HDD (Hard Disk Drive), a semiconductor memory or the like. In the storage 6, program data and a variety of setting data are stored in a readable and writable manner by the signal processor 5. Further, in the storage 6, the intimal peak wavelength λ₀ of the marker 3 is also stored.

Hereinafter a change of the reflection light spectrum intensity due to a strain produced in the marker 3 will be described referring to FIG. 3. In the example illustrated in FIG. 3, the reflection light spectrum intensity was simulated in the conditions in which the strain body 31 is made of silicone rubber, and the particles 32 is made of spherical gold (Au) with a diameter of 50 nm. Further, in the example illustrated in FIG. 3, the simulation was conducted in the conditions in which the particle spacing Y0 in the Y direction and the particle spacing Z0 in the Z direction are respectively 50 nm and 330 nm in the reference state. The particles 32 are not limited to a spherical shape but may have any shape that can readily cause polarization in a particular direction such as columnar shape (nanorods).

When there is a strain, the reflection light spectrum of the strain body 31 with the particles 32 is changed and the peak wavelength thereof is shifted accordingly, since the change of the particle spacing changes the resonance wavelength of the surface plasmon as illustrated in FIG. 3. In the example illustrated in FIG. 3, the spectrum PS2 in the state of having a strain is shifted to a longer wavelength compared to the spectrum SP1 in the reference state.

Method of Producing Marker

Methods of forming a nanosized device can be classified into mainly two types of a top-down type and a bottom-up type. The top-down type is a production technique for fine processing that has been used in semiconductor processes such as lithography and nanoimprinting. The top-down type is advantageous in high design flexibility in the structure and the shape but disadvantageous in many technical constraints in the product size and the like. The bottom-up type is a technique of building a complex structure by a spontaneous process that is based on the inherent chemical bonding and the intermolecular force of atoms and molecules without an aid of any artificial manipulation or process. The bottom-up type is suitable for producing a structure that has a periodic pattern of several nm. However, this technique is disadvantageous in the difficulty in producing a non-periodic structure and the absence of established mass production techniques. The marker 3 of the present invention can be produced by either top-down type or bottom-up type method.

Operation of Strain Sensor

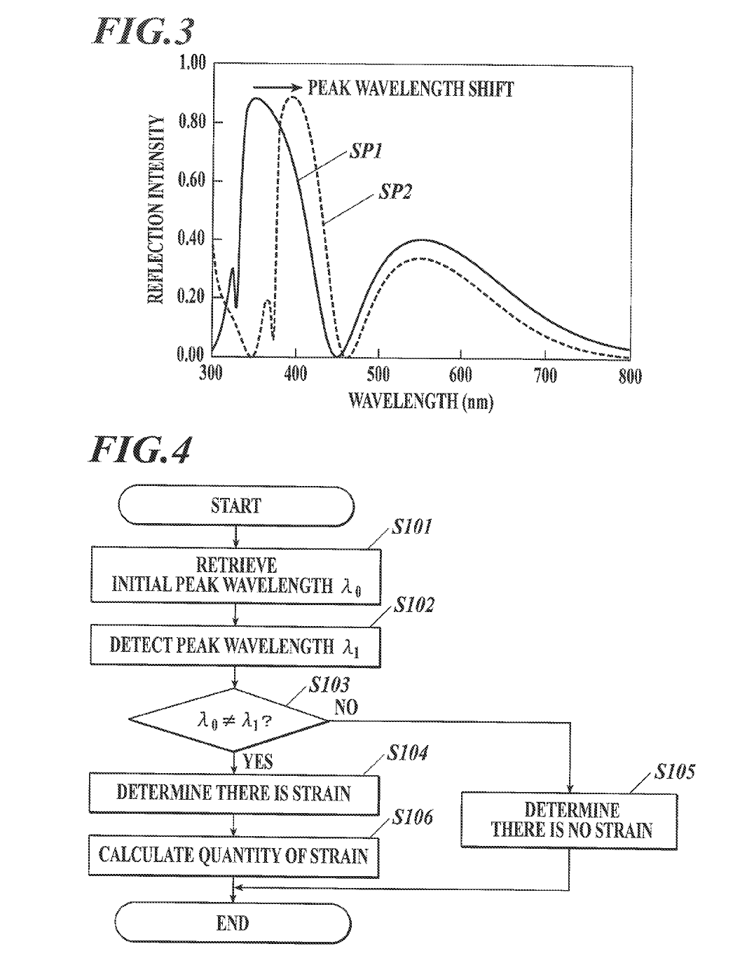

Next, the operation of the strain sensor 1 according to the embodiment will be described referring to the flowchart of FIG. 4.

First, the signal processor 5 retrieves the initial peak wavelength λ₀ prestored in the storage 6 (Step S101). The initial peak wavelength λ₀ may be either design wavelength or peak wavelength actually detected in a specific timing.

Then, the signal processor 5 detects the peak wavelength (peak of the absorption spectrum) λ₁ of the light reflected on the marker 3 based on the spectrum intensity of the light (beams) detected by the detector 4 (Step S102).

The signal processor 5 makes a determination as to whether the initial peak wavelength λ₀ retrieved in Step S101 is different from the peak wavelength λ₁ detected in Step S102 (λ₀≠λ₁) (Step S103).

When it is determined that initial peak wavelength λ₀ is different from the peak wavelength λ₁ (λ₀≠λ₁) (Step S103, Yes), the signal processor 5 determines that there is a strain (Step S104) since the particle spacing can be regarded to be changed, and the process continues with Step S106.

When it is determined that initial peak wavelength λ₀ is the same as the peak wavelength λ₁ (λ₀=λ₁) (Step S103, No), the signal processor 5 determines that there is no strain (Step S105) since the particle spacing can be regarded not to be changed, and the process ends.

The initial peak wavelength λ₀ being the same as the peak wavelength λ₁ is not necessarily limited to being completely the same value but may include the case in which the difference is within a predetermined threshold. In this case, the threshold may be suitably selected in view of the required detection accuracy of the quantity of strain, measurement errors, errors due to an environmental change and the like.

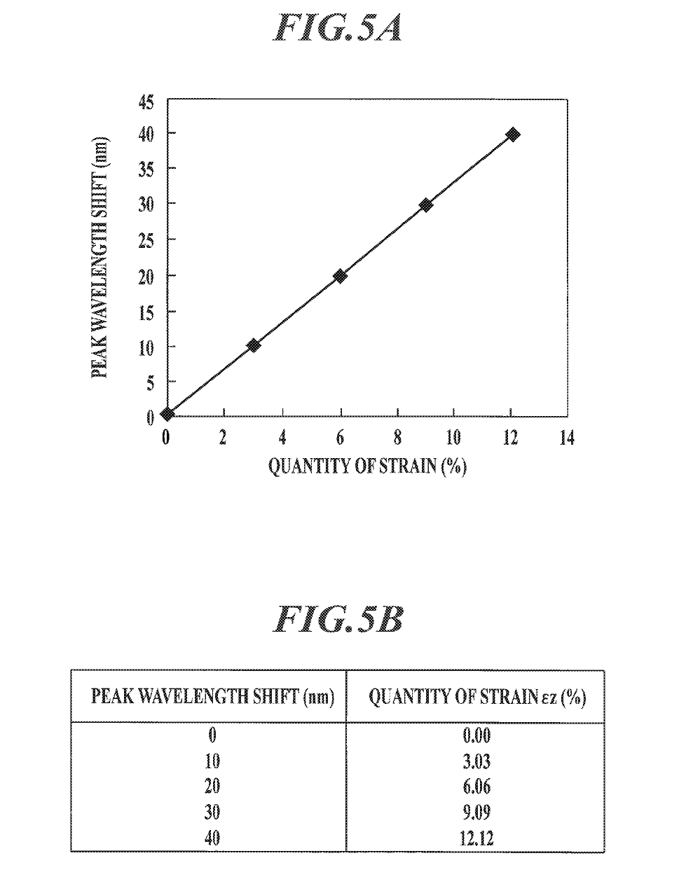

Then, the signal processor 5 calculates the amount of the strain produced (quantity of strain) that has been determined in Step S104 (Step S106). Specifically, the signal processor 5 references data table (see FIG. 5) that corresponds the quantity of strain in the marker 3 to peak wavelength shift (difference between the peak wavelength λ₁ and the initial peak wavelength λ₀), so as to calculate the quantity of strain in the marker 3. For example, in the example illustrated in FIG. 5A and FIG. 5B, when the quantity of peak wavelength shift is 20 nm, the quantity of strain εz (=6.06%) that corresponds to a peak wavelength shift of 20 nm can be calculated.

FIG. 5A illustrates a plot of the relationship between peak wavelength shift and the quantity of strain that is converted from the particle spacing. It can be seen that peak wavelength shift monotonically increases according to an increase of the quantity of strain. This characteristic is desirable for a sensor. Further, the sensitivity is also very high, which is more than twice as high as that of the conventional Bragg reflection-type sensors.

As described above, the strain sensor 1 of the embodiment includes:

the marker 3 in which surface plasmon generating particles 32 are regularly and periodically arranged in the direction (Z direction, thickness direction) normal to the light receiving surface of the strain body 31 and in the first direction (Y direction) which is an in-plane direction of the light receiving surface, in which a strain is produced in the strain body by a load;

the light source 2 that emits light to the marker 3;

the first detector (detector 4) that detects the spectrum intensity of the light reflected on the marker 3;

the second detector (signal processor 5) that detects the peak of the absorption spectrum of the light reflected on the marker 3 based on the spectrum intensity detected by the first detector; and

the calculator (signal processor 5) that calculates the quantity of strain in the direction normal to the light receiving surface based on the peak of the absorption spectrum detected by the second detector.

Further, the strain body 31 is constituted by a transparent body, and the diameter of the particles 32 is equal to or less than the wavelength of the light incident to the marker 3.

Therefore, in the strain sensor 1 according to the embodiment, the reflection light intensity can be secured without tens or hundreds of periodic particle layers in the thickness direction, and an increase of the size can be avoided accordingly. Further, the light that reaches the particles 32 inside the strain body 31 can generate plasmon inside the strain body 31 and thus secure a sufficient amount of light at the detector 4. As a result, the quantity of strain in the thickness direction can be detected with high accuracy.

In the strain sensor 1 according to the embodiment, the particles 32 are three-dimensionally arranged in the direction normal to the light receiving surface, the first direction and the second direction (X direction) that is an in-plane direction of the light receiving surface and perpendicular to the first direction.

Therefore, in the strain sensor 1 according to the embodiment, light readily reaches the particles 32. As a result, the quantity of strain in the thickness direction can be detected with even higher accuracy.

In the strain sensor 1 according to the embodiment, the spacing of particles 32 adjacent in the direction normal to the light receiving surface ranges from two to ten times of the diameter of the particles 32, and the spacing of particles 32 adjacent in the first direction is equal to or greater than the diameter of the particles 32.

Therefore, in the strain sensor 1 according to the embodiment, it is possible to suitably select the size of the particles 32 and the spacing of the particles 32. As a result, the absorption characteristic for the incident light can be improved.

In the strain sensor 1 according to the embodiment, the particles 32 contain at least a metal.

Therefore, the strain sensor 1 according to the embodiment can generate surface plasmon in the visible region. This enables detecting the spectrums with a widely-used typical spectrometer and reducing the cost.

In particular, in the strain sensor 1 according to the embodiment, the particles 32 contain at least gold or silver.

Therefore, the strain sensor 1 according to the embodiment can generate particularly strong surface plasmon in the visible region. This enables detecting the spectrums with a widely-used typical spectrometer and reducing the cost.

In the strain sensor 1 according to the embodiment, the diameter of the particles 32 ranges from 50 nm to 100 nm.

Therefore, in the strain sensor 1 according to the embodiment, the absorption characteristic in the visible region can be maximized when gold or silver is used as the material of the particles 32. As a result, the quantity of strain in the thickness direction can be detected with even higher accuracy.

In the strain sensor 1 according to the embodiment, the strain body 31 is made of an elastic material.

Therefore, in the strain sensor 1 according to the embodiment, strain can be measured by using a reversibly deformable material, and the material is usable even after expansion and contraction are repeated. As a result, the cost for the measurement can be reduced.

While the present invention is specifically described with an embodiment, the present invention is not limited to the above-described embodiment, and changes can be made without departing from the features thereof.

Variation 1

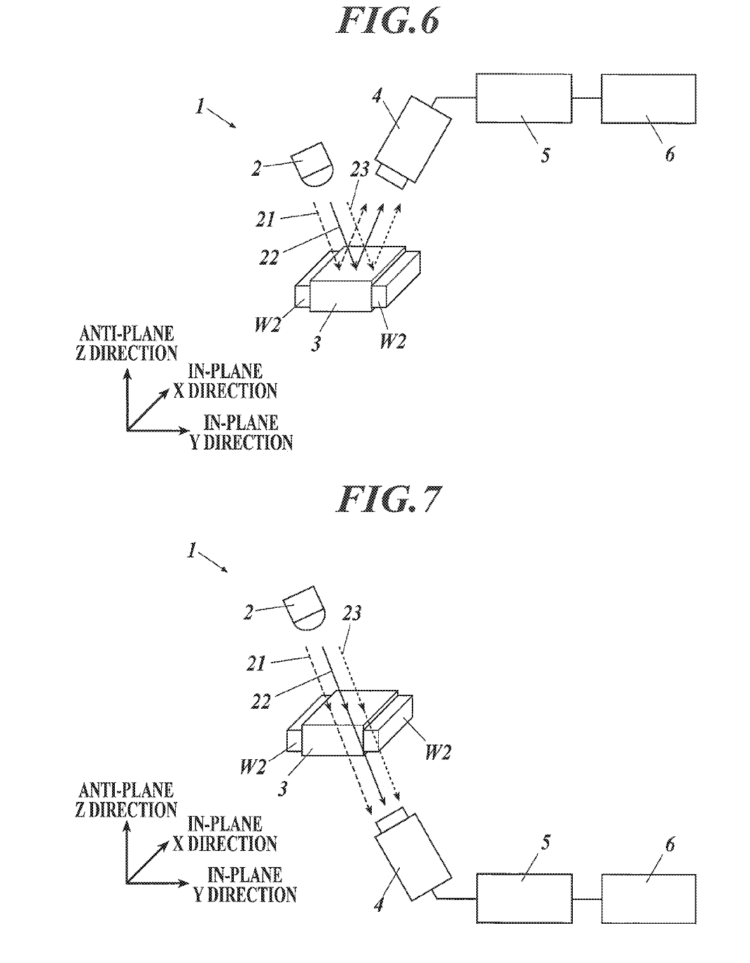

For example, in the above-described embodiment, the marker 3 is fixed on the upper surface of the fixing member W1 that is disposed below in the Z direction of the light source 2. However, the arrangement is not limited thereto. For example, as illustrated in FIG. 6, the marker 3 may be held at the outer periphery by a fixing portion W2 (e.g. at the both side faces in the Y direction as illustrated in FIG. 6) instead of the marker 3 being fixed on the upper surface of the fixing member W1.

Variation 2

The above-described embodiment illustrates an example in which the beams 21 to 23 emitted from the light source 2 are reflected on the marker 3. However, the configuration is not limited thereto. For example, the beams 21 to 23 emitted from the light source 2 may pass through the marker 3. In this case, the detector 4 is disposed at a location toward which the beams 21 to 23 that are emitted from the light source 2 and pass through the marker 3 are directed as illustrated in FIG. 7, and the light source 2 detects the spectrum intensity of the light that has passed through the marker 3. In the embodiment, the fixing member W1 is constituted by a transparent body so that the beams 21 to 23 can pass through the fixing member W1 as well as the marker 3.

As described above, the strain body 31 and a measurement object W are constituted by transparent bodies, and the first detector (detector 4) detects the spectrum intensity of the light that has passed through the marker 3. Therefore, since the quantity of strain can be measured based on light that has passed through the marker 3 and the measurement object W, the flexibility is secured with regard to the arrangement of the detector 4 and the like.

Other Variations

In the above-described embodiment, the particles 32 are three-dimensionally arranged in the Z, Y and X directions. However, the arrangement is not limited thereto. That is, any configuration is possible as long as the particles 32 are arranged at least two-dimensionally in the Z and Y directions.

In the above-described embodiment, for example, the beams 21 to 23 emitted from the light source 2 are diagonally incident to the light receiving surface of the marker 3 as illustrated in FIG. 1 and the like. However, the configuration is not limited thereto. That is, the beams 21 to 23 emitted from the light source 2 may be perpendicularly incident to the light receiving surface of the marker 3. For example, when the light source 2 is a laser light source, linearly polarized light is emitted to the detector 4, and the incident angle other than 90 degrees causes the occurrence of a TE wave component and a TM wave component. Since the ratio of the TE wave component and the TM wave component depends on the incident angle of the beams and the arrangement angle of the laser, these factors counts as errors. That is, when the incident angle is 90 degrees, a noise factor of the polarization characteristic being dependent on the incident angle can be eliminated since the TE wave and the TM wave have no difference. Therefore, the measurement can be made with even higher accuracy, and this configuration is further preferred in this regard.

As described above, since the light emitted from the light source 2 is perpendicularly incident to the light receiving surface of the marker 3, there is no polarization characteristic that depends on the incident angle. Therefore, it is possible to perform the measurement with even higher accuracy by reducing the noise.

The above-described embodiment illustrates an example in which the particles 32 contain at least a metal. However, the particles 32 are not limited thereto. That is, the particles 32 are not limited to the above-described configuration of containing at least a metal and may contain at least an oxide semiconductor instead. In this case, examples of oxide semiconductors for the particles 32 include zinc oxide and the like. When zinc oxide is used, it is possible to carry out a measurement in a dark environment and to eliminate the influence of environmental light since zinc oxide exhibits the peak of the absorption spectrum of the surface plasmon in the near-infrared region. Furthermore, zinc oxide is inexpensive and can be readily formed into nanoparticles.

As described above, the particles 32 that contain at least a semiconductor oxide can generate surface plasmon in the near-infrared region. This enables detection of the spectrum even in a dark environment. As a result, the flexibility in measurement time and measurement site can be ensured.

Further, the particles 32 that contain at least zinc oxide can generate particularly intense surface plasmon in the near-infrared region. This enables detecting the spectrum even in a dark environment. As a result, the flexibility in measurement time and measurement site can be secured.

The present invention is also applicable to apparatuses such as image forming apparatuses. Specifically, applying the present invention to an image forming apparatus enables detecting the distribution of the film pressure change in a transfer rollers and the like supporting an endless film, which is caused by a stress load.

In addition, suitable changes can be made also to the detailed configurations and the detailed operation of the components of the strain sensor without departing from the features of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2016-250394, filed on Dec. 26, 2016, is incorporated herein by reference in its entirety.

What is claimed is:

1. A strain sensor, comprising:
a marker which comprises a strain body and surface plasmon generating particles which are regularly and periodically arranged in the strain body in a direction normal to a light receiving surface of the strain body and in a first direction that is an in-plane direction of the light receiving surface, in which a strain is produced in the strain body by a load;
a light source which emits light to the marker;
a first detector which detects a spectrum intensity of the light which has been reflected on the marker or which has passed through the marker;
a second detector which detects a peak of an absorption spectrum of the light which has been reflected on the marker or which has passed through the marker, based on the spectrum intensity detected by the first detector; and
a calculator which calculates the quantity of strain in the direction normal to the light receiving surface from the peak of the absorption spectrum detected by the second detector,
wherein the strain body is constituted by a transparent body, and
wherein a diameter of the particles is equal to or less than the wavelength of the light incident to the marker.

2. The strain sensor according to claim 1, wherein the particles are three-dimensionally arranged in the direction normal to the light receiving surface, the first direction and a second direction which is an in-plane direction of the light receiving surface perpendicular to the first direction.

3. The strain sensor according to claim 1,
wherein spacing of the particles in the direction normal to the light receiving surface ranges from two to ten times of the diameter of the particles, and
wherein spacing of the particles in the first direction is equal to or greater than the diameter of the particles.

4. The strain sensor according to claim 1, wherein the light emitted from the light source is perpendicularly incident to the light receiving surface of the marker.

5. The strain sensor according to claim 1, wherein the particles contain at least a metal.

6. The strain sensor according to claim 5, wherein the particles contain at least gold or silver.

7. The strain sensor according to claim 6, wherein the diameter of the particles ranges from 50 nm to 100 nm.

8. The strain sensor according to claim 1, wherein the particles contain at least an oxide semiconductor.

9. The strain sensor according to claim 8, wherein the particles contain at least zinc oxide.

10. The strain sensor according to claim 1, wherein the strain body is made of an elastic material.

11. A strain measuring method for a strain sensor which comprises:
a marker which comprises a strain body and surface plasmon generating particles which are regularly and periodically arranged in the strain body in a direction normal to a light receiving surface of the strain body and in a first direction that is an in-plane direction of the light receiving surface, in which a strain is produced in the strain body by a load;
a light source which emits light to the marker; and
a first detector which detects a spectrum intensity of the light which has been reflected on the marker or which has passed through the marker,
the method comprising:
detecting a peak of an absorption spectrum of the light which has been reflected on the marker or which has passed through the marker, based on the spectrum intensity detected by the first detector; and
calculating the quantity of strain in the direction normal to the light receiving surface from the detected peak of the absorption spectrum,
wherein the strain body is constituted by a transparent body, and
wherein a diameter of the particles is equal to or less than the wavelength of the light incident to the marker.
